(19) United States
(12) Patent Application Publication
(10) Pub. No.: US 2014/0181737 A1
(43) Pub. Date: Jun. 26, 2014

(54) METHOD FOR PROCESSING CONTENTS AND ELECTRONIC DEVICE THEREOF

(71) Applicant: SAMSUNG ELECTRONICS CO., LTD., Suwon-si (KR)

(72) Inventors: Soo-Ji HWANG, Suwon-si (KR); Ji-Yoon PARK, Suwon-si (KR); Chang-Hyun AHN, Suwon-si (KR); Ha-Na LEE, Seoul (KR)

(73) Assignee: SAMSUNG ELECTRONICS CO., LTD., Suwon-si (KR)

(21) Appl. No.: 14/104,527

(22) Filed: Dec. 12, 2013

(30) Foreign Application Priority Data
Dec. 20, 2012 (KR) 10-2012-0149787

(51) Int. Cl. G06F 3/0484; G06F 3/0488

(52) U.S. Cl. CPC G06F 3/04845; G06F 3/0488
USPC 715/800

(57) ABSTRACT

A method for enlarging contents and an electronic device thereof are provided. The method includes displaying contents on a front side of a double-sided touch-sensitive display, detecting a selection for enlarging a specific area of the contents, upon the detection of selection, switching the double-sided touch-sensitive display to a semi-transparent mode, sensing a touch on a rear side of the double-sided touch-sensitive display, and displaying a threshold area of the double-sided touch-sensitive display corresponding to a coordinate at which the touch is sensed by enlarging the area by a pre-set magnification factor.

### CROSS-REFERENCE TO RELATED APPLICATION(S)

This application claims the benefit under 35 U.S.C. §119(a) of a Korean patent application filed on Dec. 20, 2012 in the Korean Intellectual Property Office and assigned Serial No. 10-2012-0149787, the entire disclosure of which is hereby incorporated by reference.

### TECHNICAL FIELD

The present disclosure relates to an electronic device. More particularly, the present disclosure relates to a method and apparatus for processing contents in an electronic device.

### BACKGROUND

With the rapid technological advances of electronic devices (e.g., a smart phone, a tablet Personal Computer (PC), etc.), an electronic device capable of wireless voice telephony and information exchange has become increasingly popular and is effectively a necessity of everyday life. Upon introduction and first distribution, the electronic device was recognized as a portable device capable of simple wireless telephony. However, with advances in related technologies and wireless Internet, the electronic device has been further developed into a multimedia device for performing advanced functions such as scheduling, games, remote control, image capturing, projectors, etc.

Since convenience and portability of the electronic device are important, compact electronic devices have recently been launched. However, if contents are displayed on such a compact electronic device, it is inconvenient for a user to use the contents due to a small-sized display. For example, if an image including small-sized alphanumeric characters is displayed in a compact smart phone, it is inconvenient to read the alphanumeric characters included in the image due to a small-sized touch screen. Therefore, the electronic device provides a magnifier mode to enlarge a portion selected by the user when displayed. However, in case of the magnifier mode, there is an area which cannot be viewed or controlled by the user due to a touch entity or an indication pointer for indicating an enlarged area.

Accordingly, there is a need to provide an apparatus and method for enlarging and controlling a user's desired area in contents.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and apparatus for enlarging contents in an electronic device.

Another aspect of the present disclosure is to provide a method and apparatus for setting a double-sided touch-sensitive display to be semi-transparent in an electronic device.

Another aspect of the present disclosure is to provide a method and apparatus for sensing a touch on a rear side of a double-sided touch-sensitive display in an electronic device.

Another aspect of the present disclosure is to provide a method and apparatus for displaying a threshold area of a double-sided touch-sensitive display corresponding to a coordinate at which a touch is sensed in an electronic device by enlarging the threshold area by a magnification factor.

Another aspect of the present disclosure is to provide a method and apparatus for controlling a transparency of a double-sided display in a magnifier mode in an electronic device.

In accordance with an aspect of the present disclosure, a method of controlling an electronic device is provided. The method includes displaying contents on a front side of a double-sided touch-sensitive display, detecting a selection for enlarging a specific area of the contents, upon the detection of the selection, switching the double-sided touch-sensitive display to a semi-transparent mode, sensing a touch on a rear side of the double-sided touch-sensitive display, and displaying a threshold area of the double-sided touch-sensitive display corresponding to a coordinate at which the touch is sensed by enlarging the area by a magnification factor.

In accordance with another aspect of the present disclosure, an electronic device is provided. The electronic device includes one or more processors, a double-sided touch-sensitive display, a memory, and one or more programs stored in the memory and configured to be executed by the one or more processors, wherein the one or more programs include an instruction for displaying contents on a front side of a double-sided touch-sensitive display, for detecting a selection for enlarging a specific area of the contents, for, upon the detection of selection, switching the double-sided touch-sensitive display to a semi-transparent mode, for sensing a touch on a rear side of the double-sided touch-sensitive display, and for displaying a threshold area of the double-sided touch-sensitive display corresponding to a coordinate at which the touch is sensed by enlarging the area by a magnification factor.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features and advantages of certain embodiments of the present disclosure will be more apparent from the following detailed description taken in conjunction with the accompanying drawings, in which:

FIG. 1A is a block diagram illustrating a structure of an electronic device for enlarging contents according to an embodiment of the present disclosure;

FIG. 1B is a block diagram illustrating a structure of a processor for enlarging contents according to an embodiment of the present disclosure;

FIG. 2 illustrates a process of enlarging contents by sensing a touch on a rear side of a double-sided touch-sensitive display in an electronic device according to an embodiment of the present disclosure;

FIGS. 3A and 3B illustrate a process of enlarging and editing contents by using a double-sided touch-sensitive display in an electronic device according to an embodiment of the present disclosure;

FIGS. 4A, 4B, 4C, 4D, 4E, and 4F illustrate an example of enlarging and editing contents by using a double-sided touch-sensitive display in an electronic device according to an embodiment of the present disclosure;

FIG. 5 illustrates a transparency of a display according to an embodiment of the present disclosure;

FIG. 6 illustrates an example of determining an enlarged area in an electronic device according to an embodiment of the present disclosure;

FIG. 7 illustrates an example of enlarging a double-sided touch sensitive display to change a page in an electronic device according to an embodiment of the present disclosure;

FIG. 8 illustrates an example of controlling a size of an enlarged area by sensing multiple touches in an electronic device according to an embodiment of the present disclosure;

FIG. 9 illustrates an example of an enlarged area based on a touch position in an electronic device according to an embodiment of the present disclosure;

FIG. 10 illustrates an example of enlarging and moving a plurality of touch-sensed points in an electronic device according to an embodiment of the present disclosure; and

FIG. 11 illustrates a shape of an enlarged area in an electronic device according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the following description, the term “electronic device” denotes a mobile communication terminal, a smart phone, a tablet Personal Computer (PC), a Motion Picture Experts Group Layer 3 (MP3) player, a navigator, etc., as long as it allows touch sensing on both of its front side and rear side of the electronic device and is capable of setting a display panel to be transparent.

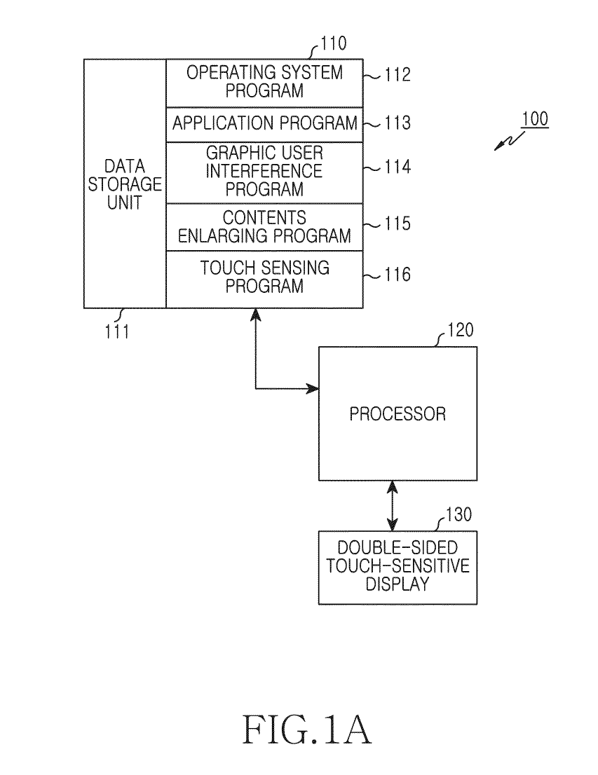

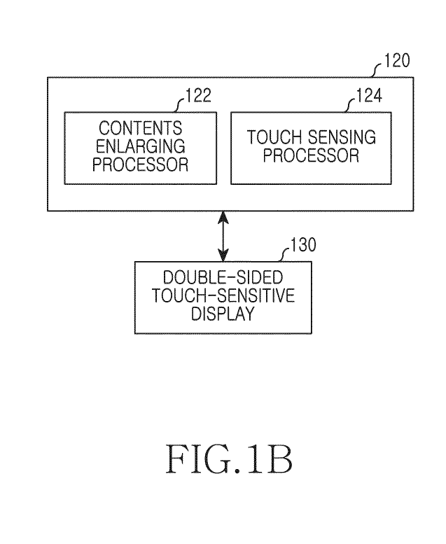

FIG. 1A is a block diagram illustrating a structure of an electronic device for enlarging contents according to an embodiment of the present disclosure.

Referring to FIG. 1A, an electronic device 100 includes a memory 110, a processor 120, and a double-sided touch-sensitive display 130. The memory 110 and the processor 120 may be plural in number.

The memory 110 includes a data storage unit 111, an operating system program 112, an application program 113, a graphic user interference program 114, a contents enlarging program 115, a touch sensing program 116, etc. In addition, since a program which is a software component can be expressed in a group of instructions, the program is also expressed in an instruction set. The program may also be expressed in a module.

The memory 110 may store one or more programs including instructions for executing embodiments of the present disclosure.

The data storage unit 111 stores data generated while performing a function corresponding to the program stored in the memory 110. If it is sensed that contents are touched on a rear side of the double-sided touch-sensitive display 130, the data storage unit 111 may store a magnification factor for enlarging a threshold area of a front side of the double-sided touch-sensitive display 130 with a touch-sensed point as its center. In addition, the data storage unit 111 may store a gesture for fixing an enlarged area of the contents. In this case, the gesture includes at least one of a tap for a specific time or longer, a multi-tap, a double-tap, etc.

The operating system program 112 (e.g., a built-in operating system such as WINDOWS, LINUX, Darwin, RTXC, UNIX, OS X, VxWorks, etc.) includes various software components for controlling a general system operation. For example, the control of the general system operation includes memory management and control, storage hardware (device) control and management, power control and management, etc. The operating system program 112 performs a function for facilitating communication between various hardware components (devices) and software components (programs).

The application program 113 includes a browser, an email, a message, word processing, an address book, a widget, a Digital Right Management (DRM), voice recognition, voice recording, a position determining function, a location based service, a telephone, etc.

The graphic user interface program 114 includes at least one software component for providing a graphic-based user interface between the user and the electronic device 100. That is, the graphic user interface program 114 includes at least one software component for displaying user interface information on the double-sided touch-sensitive display 130. According to the present disclosure, the graphic user interface program 114 includes an instruction for displaying contents on the front side and/or the rear side of the double-sided touch-sensitive display 130. In this case, the contents include all types of applications and contents that can be executed by the electronic device 100. For example, the graphic user interface program 114 includes an instruction for displaying image contents on the front side of the double-sided touch-sensitive display 130. For another example, the graphic user interface program 114 includes an instruction for displaying web-browser contents on the front side of the double-sided touch-sensitive display 130.

In addition, the graphic user interference program 114 includes an instruction for displaying a threshold area of the front side of the double-sided touch-sensitive display 130 corresponding to a coordinate at which a touch is sensed by enlarging the area by a magnification factor, if it is sensed that the rear side of the double-sided touch-sensitive display 130 is touched in a magnifier mode. In this case, the double-sided touch-sensitive display 130 may enlarge and display the area by applying the same effect as when it is enlarged through a magnifier in the threshold area determined according to the coordinate at which the touch is sensed.

FIG. 5 illustrates a transparency of a display according to an embodiment of the present disclosure.

Referring to FIG. 5, if the electronic device operates in the magnifier mode, the contents enlarging program 115 sets the double-sided touch-sensitive display 130 to be semi-transparent. Herein, the semi-transparent state implies an intermediary state between a transparent state in which a user's finger located on the rear side of the double-sided touch-sensitive display 130 is clearly visible through the front side thereof and an opaque state in which the user's finger located on the rear side of the double-sided touch-sensitive display 130 is not visible through the front side thereof. That is, as illustrated in FIG. 5, the transparent state is a state in which a transparency is set to 100% and thus the user's finger located on the rear side is clearly visible through the front side. The opaque state is a state in which the transparency is set to 0% and thus the user's finger located on the rear side is not visible at all through the front side. The semi-transparent state is a state in which the transparency is set to a value greater than or equal to 0% and less than 100%, and thus the user's finger located on the rear side is not clearly visible through the front side.

In this case, the contents enlarging program 115 may set the double-sided touch-sensitive display 130 to be semi-transparent to reflect an object located on the rear side of the double-sided touch-sensitive display 130, while displaying the contents on the front side of the double-sided touch-sensitive display 130. For example, if the magnifier mode is set, the contents enlarging program 115 may control the double-sided touch-sensitive display 130 so that a user's finger located on the rear side of the double-sided touch-sensitive display 130 is reflected to the front side, while displaying the contents on the front side of the double-sided touch-sensitive display 130.

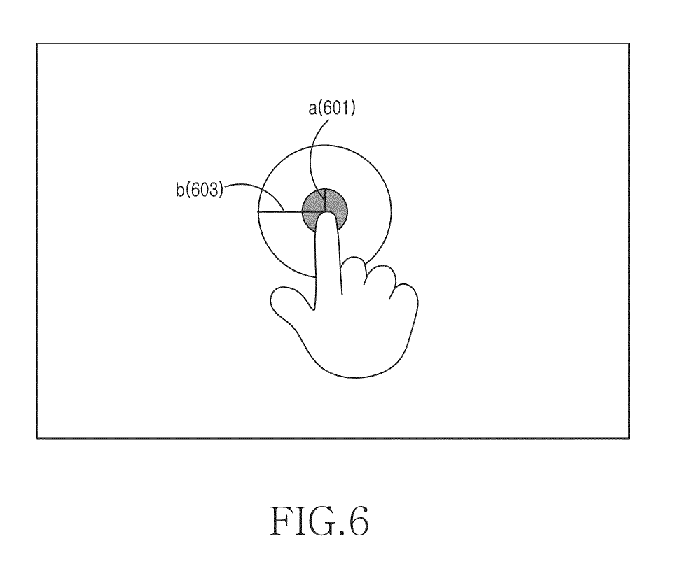

FIG. 6 illustrates an example of determining an enlarged area in an electronic device according to an embodiment of the present disclosure.

Referring to FIG. 6, if a touch is sensed on the rear side of the double-sided touch-sensitive display 130 in a state where the double-sided touch-sensitive display 130 is set to be semi-transparent, the contents enlarging program 115 enlarges and displays a threshold area around a coordinate of the front side of the contents enlarging program 115 corresponding to a coordinate at which a touch is sensed. For example, as illustrated in FIG. 6, the contents enlarging program 115 determines a circular area having a radius ‘a’ 601 with a touch-sensed point as its center to an area to be enlarged, enlarges the area to be enlarged by a magnification factor, i.e., n times, and thus displays an area enlarged by a circular area having a radius b 603 where b=a*n.

In this case, in a full area of the double-sided touch-sensitive display 130 which is set to be semi-transparent, only the enlarged area can be released from the transparency setting by the contents enlarging program 115. Herein, the releasing of the semi-transparent setting of the enlarged area implies that a transparency of the enlarged area is set to 0% and the enlarged area is switched to the opaque state in the double-sided touch-sensitive display 130. Accordingly, the electronic device 100 may provide the user with the enlarged area with a clear view. In another embodiment, in the full area of the double-sided touch-sensitive display 130, the contents enlarging program 115 may decrease the transparency or release the semi-transparent setting only in the enlarged area. For example, if a transparency of the touch-sensitive display 130 is currently 50%, the contents enlarging program 115 may set the transparency of the touch-sensitive display 130 for the enlarged area to a value less than 50%.

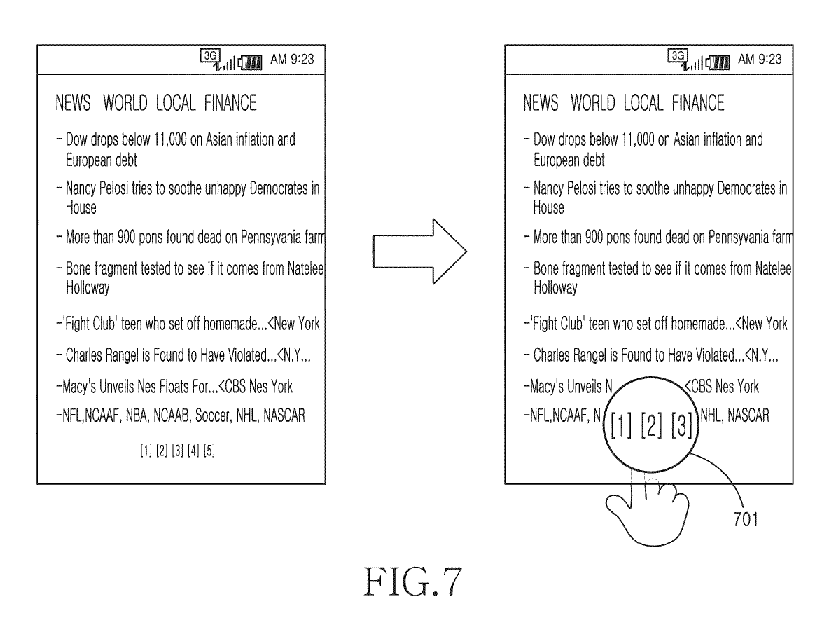

FIG. 7 illustrates an example of enlarging a double-sided touch sensitive display to change a page in an electronic device according to an embodiment of the present disclosure.

Referring to FIG. 7, if a gesture on the enlarged area is sensed on the front or rear side of the double-sided touch-sensitive display 130, the contents enlarging program 115 may fix the enlarged area. Herein, the gesture includes a tap for a specific time or longer, a multi-tap, a double-tap, and the like. For example, if the tap for the specific time or longer is sensed on the enlarged area, the contents enlarging program 115 may fix the enlarged area to maintain an enlarged state in a position at which a user touch is sensed. In this case, if the enlarged area of contents is fixed, the contents enlarging program 115 may edit the enlarged area of the contents under the user control. For example, if a specific area of image contents is enlarged, the contents enlarging program 115 may edit the enlarged area of the image contents by using an image edit tool. In addition, if the enlarged area of the contents is fixed, the contents enlarging program 115 detects that the enlarged area of the contents is selected, and performs a function corresponding to the detected selected area. For example, as illustrated in FIG. 7, in a state where an area of contents including a link for a page change is enlarged, the contents enlarging program 115 may sense a touch on an enlarged area 701 of the contents, and thereafter may change a page by moving to an address corresponding to a link of a touch-sensed area.

If a drag progresses in a state where the enlarged area is not fixed, the contents enlarging program 115 may enlarge an area of displayed contents corresponding to a position at which the drag progresses by a magnification factor.

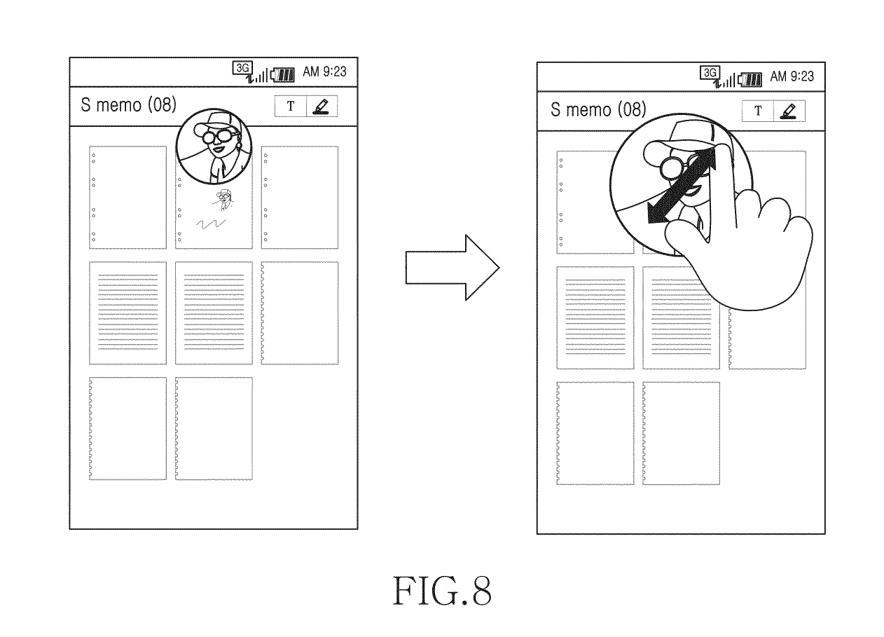

FIG. 8 illustrates an example of controlling a size of an enlarged area by sensing multiple touches in an electronic device according to an embodiment of the present disclosure.

Referring to FIG. 8, the contents enlarging program 115 may sense multiple touches on an enlarged area on the front or rear side of the double-sided touch-sensitive display 130, and may regulate a size of the enlarged area or a magnification factor of contents. For example, if a circular threshold area corresponding to a coordinate A at which a user's touch is sensed is enlarged to an area having a diameter R and thereafter two drags diverging from each other are detected in the enlarged area, the contents enlarging program 115 may increase the size of the enlarged area having the diameter R to an area having a diameter R1 (R1>R) according to a length of drag progression. For another example, if two drags converging with each other are detected in the enlarged area, the contents enlarging program 115 may decrease the size of the enlarged area having the diameter R to an area having a diameter R2 (R2<R) according to the length of drag progression. For another example, if two drags diverging from each other in the enlarged area are detected, the contents enlarging program 115 may increase a magnification factor of contents according to the length of drag progression while maintaining the size of the enlarged area. For another example, if two drags converging with each other are detected in the enlarged area, the contents enlarging program 115 may decrease the magnification factor of contents according to the length of drag progression while maintaining the size of the enlarged area.

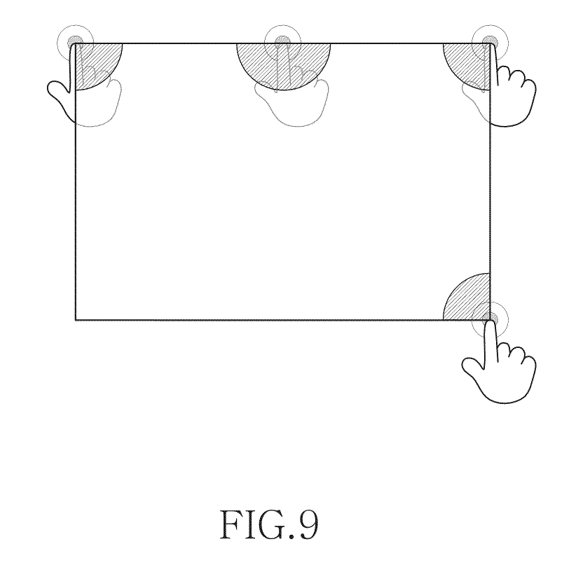

FIG. 9 illustrates an example of an enlarged area based on a touch position in an electronic device according to an embodiment of the present disclosure.

Referring to FIG. 9, if a touch is sensed on a corner of the rear side of the double-sided touch-sensitive display 130, the contents enlarging program 115 may enlarge the touch detected area as illustrated.

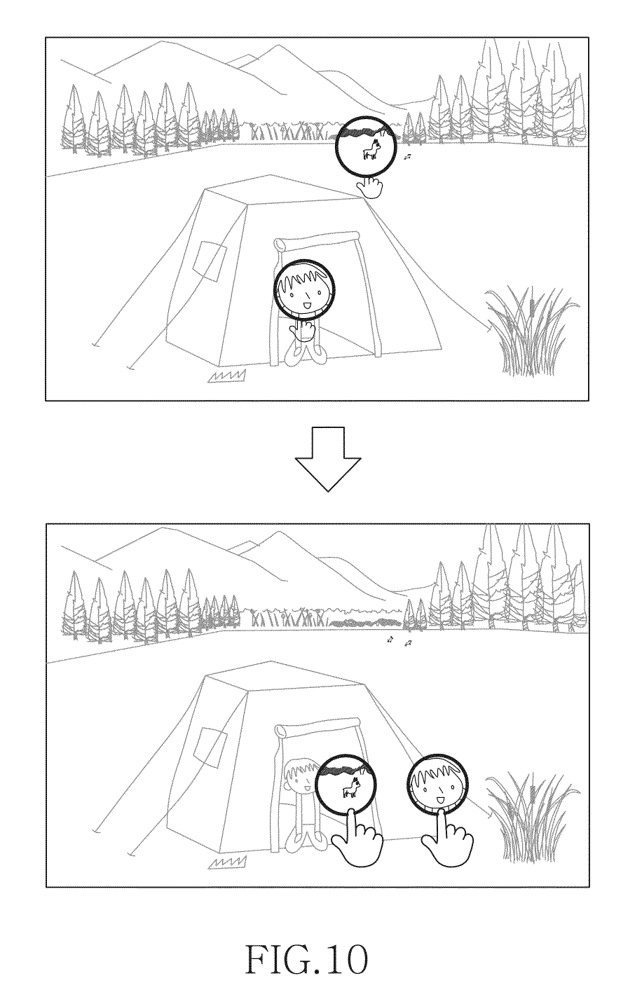

FIG. 10 illustrates an example of enlarging and moving a plurality of touch-sensed points in an electronic device according to an embodiment of the present disclosure.

Referring to FIG. 10, if multiple touches are sensed on the rear side of the double-sided touch-sensitive display 130, the contents enlarging program 115 may display a threshold area by enlarging the threshold area around a coordinate of the front side of the double-sided touch-sensitive display 130 corresponding to each coordinate at which the multi-touch is sensed, may detect a drag in each enlarged area, and may move each enlarged area according to a progression direction of the detected drag. For example, as illustrated in FIG. 10, on the rear side of the double-sided touch-sensitive display 130, if two touches are sensed on image contents displayed on the front side of the double-sided touch-sensitive display 130, the touch-sensed two areas may be enlarged and displayed, a drag may be detected in each enlarged area, and each enlarged area may be moved according to a direction of the detected drag.

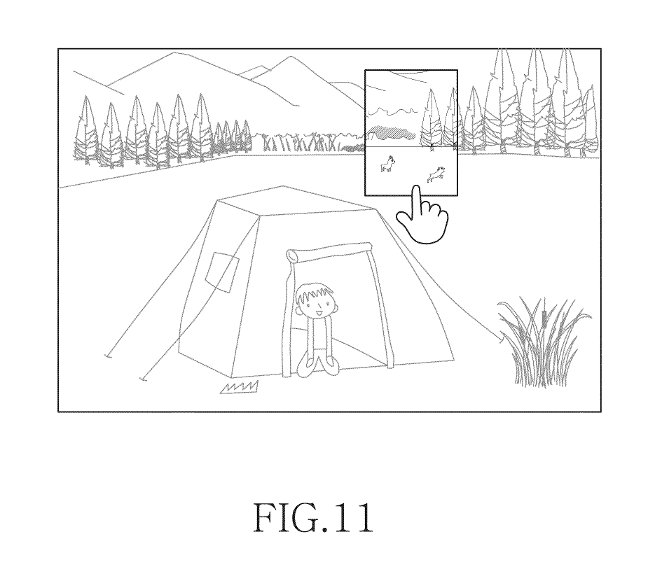

FIG. 11 illustrates a shape of an enlarged area in an electronic device according to an embodiment of the present disclosure.

Referring to FIG. 11, the contents enlarging program 115 may display the enlarged area of contents in a circular or polygonal shape. For example, as illustrated in FIG. 11, the contents enlarging program 115 may display an enlarged area in a quadrangular shape.

The touch sensing program 116 may detect a touch on the front side and the rear side of the double-sided touch-sensitive display 130. First, the touch sensing program 116 may detect a touch on the rear side of the double-sided touch-sensitive display 130 to enlarge a threshold area of contents displayed on the front side of the double-sided touch-sensitive display 130. In this case, if the double-sided touch-sensitive display 130 is set to be semi-transparent, the touch on contents displayed on the front side of the touch sensing program 116 may be sensed on the rear side of the double-sided touch-sensitive display 130.

In addition, the touch sensing program 116 may detect a drag on the enlarged area to move the enlarged area of contents.

In addition, the touch sensing program 116 may detect a gesture on the enlarged area to fix the enlarged area of contents. In this case, the gesture includes at least one of a tap for a specific time or longer, a multi-tap, a double-tap, and the like.

In addition, the touch sensing program 116 may detect multiple touches on the enlarged area to regulate a size of the enlarged area or a magnification factor of contents. For example, the touch sensing program 116 may detect two drags diverging from each other to increase the size of the enlarged area. For another example, the touch sensing program 116 may detect drags converging with each other to decrease the size of the enlarged area.

Although not shown, the processor 120 may include at least one processor and a peripheral interface. In addition, the processor 120 executes a specific program (instruction set) stored in the memory 110 to perform a plurality of specific functions corresponding to the program.

The double-sided touch-sensitive display 130 employs a touch-sensitive display for providing an interface of a touch input/output between a user and the electronic device 100 on the front side and the rear side of the electronic device 100. The double-sided touch-sensitive display 130 is a medium for sensing a touch (or contact) on the front and/or rear side of the electronic device 100 through a touch sensor (not shown), for delivering the detected touch input to the electronic device 100, and for visually providing an output from the electronic device 100 to the user. That is, in response to the touch input, the double-sided touch-sensitive display 130 provides the user with a visual output based on texts, graphics, and videos. The double-sided touch-sensitive display 130 may provide the visual output on the front side of the double-sided touch-sensitive display 130, and may also provide the output on the rear side of the double-sided touch-sensitive display 130. In this case, the front side and the rear side of the double-sided touch-sensitive display 130 may display the same graphic, or may display different graphics.

The double-sided touch-sensitive display 130 includes a touch-sensitive surface for detecting a user's touch input, and may detect a touch input by using a haptic contact, a tactile contact, or a combination of the two. For example, a touch-sensed point of the double-sided touch-sensitive display 130 may correspond to a digit of a finger used in a contact on the touch-sensitive surface. In addition, the double-sided touch-sensitive display 130 may detect a contact made by an external device such as a stylus pen, etc., through the touch-sensitive surface. The detected contact is converted to an interaction corresponding to a user interface object (e.g., a soft key) displayed on a touch screen.

The double-sided touch-sensitive display 130 may be set to be semi-transparent under the user control, and may display contents or graphic components in a semi-transparent manner. That is, the double-sided touch-sensitive display 130 may semi-transparently display contents of the front side of the double-sided touch-sensitive display 130 so that an object located on the rear side of the double-sided touch-sensitive display 130 is reflected on the front side of the double-sided touch-sensitive display 130. In this case, the double-sided touch-sensitive display 130 may semi-transparently display the contents or graphic components displayed on the front side by controlling brightness.

The double-sided touch-sensitive display 130 may display the contents on the front side of the double-sided touch-sensitive display 130. In this case, the contents may include all types of applications and contents that can be executed in the electronic device 100. For example, the double-sided touch-sensitive display 130 may display image contents on the front side of the double-sided touch-sensitive display 130. In addition, when a magnifier mode is set, the double-sided touch-sensitive display 130 may detect a touch on the rear side of the double-sided touch-sensitive display 130. In this case, according to a sensed touch, the double-sided touch-sensitive display 130 displays the contents displayed on the front side of the double-sided touch-sensitive display 130 by enlarging the contents by a magnification factor. In addition, the double-sided touch-sensitive display 130 may detect a multi-touch and a gesture on the enlarged area of the contents.

FIG. 1B is a block diagram illustrating a structure of a processor for enlarging contents according to an embodiment of the present disclosure.

Referring to FIG. 1B, a processor 120 includes a contents enlarging processor 122 and a touch sensing processor 124.

If the electronic device operates in a magnifier mode, the contents enlarging processor 122 sets a double-sided touch-sensitive display 130 to be semi-transparent. Herein, the semi-transparent state implies an intermediary state between a transparent state in which a user's finger located on the rear side of the double-sided touch-sensitive display 130 is clearly visible through the front side thereof and an opaque state in which the user's finger located on the rear side of the double-sided touch-sensitive display 130 is not visible through the front side thereof. That is, as illustrated in FIG. 5, the transparent state is a state in which a transparency is set to 100% and thus the user's finger located on the rear side is clearly visible through the front side. The opaque state is a state in which the transparency is set to 0% and thus the user's finger located on the rear side is not visible at all through the front side. The semi-transparent state is a state in which the transparency is set to a value greater than or equal to 0% and less than 100%, and thus the user's finger located on the rear side is not clearly visible through the front side.

In this case, the contents enlarging processor 122 may set the double-sided touch-sensitive display 130 to be semi-transparent to reflect an object located on the rear side of the double-sided touch-sensitive display 130, while displaying the contents on the front side of the double-sided touch-sensitive display 130. For example, if the magnifier mode is set, the contents enlarging processor 122 may control the double-sided touch-sensitive display 130 so that a user's finger located on the rear side of the double-sided touch-sensitive display 130 is reflected to the front side, while displaying the contents on the front side of the double-sided touch-sensitive display 130.

In addition, if a touch is sensed on the rear side of the double-sided touch-sensitive display 130 in a state where the double-sided touch-sensitive display 130 is set to be semi-transparent, the contents enlarging processor 122 enlarges and displays a threshold area around a coordinate of the front side of the contents enlarging program 115 corresponding to a coordinate at which a touch is sensed. For example, as illustrated in FIG. 6, the contents enlarging processor 122 determines a circular area having a radius ‘a’ 601 with a touch-sensed point as its center to an area to be enlarged, enlarges the area to be enlarged by a magnification factor, i.e., n times, and thus displays an area enlarged by a circular area having a radius b 603 wherein b=a*n.

In this case, in a full area of the double-sided touch-sensitive display 130 which is set to be semi-transparent, only the enlarged area can be released from the transparency setting by the contents enlarging processor 122. Herein, the releasing of the semi-transparent setting of the enlarged area implies that a transparency of the enlarged area is set to 0% and the enlarged area is switched to the opaque state in the double-sided touch-sensitive display 130. Accordingly, the electronic device 100 may provide the user with the enlarged area with a clear view. In another embodiment, in the full area of the double-sided touch-sensitive display 130, the contents enlarging processor 122 may decrease the transparency or release the semi-transparent setting only in the enlarged area. For example, if a transparency of the touch-sensitive display 130 is currently 50%, the contents enlarging processor 122 may set the transparency of the touch-sensitive display 130 for the enlarged area to a value less than 50%.

In addition, if a gesture on the enlarged area is sensed on the front or rear side of the double-sided touch-sensitive display 130, the contents enlarging processor 122 may fix the enlarged area. Herein, the gesture includes a tap for a specific time or longer, a multi-tap, a double-tap, and the like. For example, if the tap for the specific time or longer is sensed on the enlarged area, the contents enlarging processor 122 may fix the enlarged area to maintain an enlarged state in a position at which a user touch is sensed. In this case, if the enlarged area of contents is fixed, the contents enlarging processor 122 may edit the enlarged area of the contents under the user control. In addition, if the enlarged area of the contents is fixed, the contents enlarging processor 122 detects that the enlarged area of the contents is selected, and performs a function corresponding to the detected selected area. For example, as illustrated in FIG. 7, in a state where an area of contents including a link for a page change is enlarged, the contents enlarging processor 122 may sense a touch on an enlarged area 701 of the contents, and thereafter may change a page by moving to an address corresponding to a link of a touch-sensed area.

For example, if a specific area of image contents is enlarged, the contents enlarging processor 122 may edit the enlarged area of the image contents by using an image edit tool.

If a drag progresses in a state where the enlarged area is not fixed, as illustrated in FIG. 8, the contents enlarging processor 122 may enlarge an area of displayed contents corresponding to a position at which the drag progresses by a magnification factor.

In addition, the contents enlarging processor 122 may detect multiple touches on an enlarged area on the front or rear side of the double-sided touch-sensitive display 130, and may regulate a size of the enlarged area or a magnification factor of contents. For example, if a circular threshold area corresponding to a coordinate A at which a user's touch is sensed is enlarged to an area having a diameter R and thereafter two drags diverging from each other are detected in the enlarged area, the contents enlarging processor 122 may increase the size of the enlarged area having the diameter R to an area having a diameter R1 (R1>R) according to a length of drag progression. For another example, if two drags converging with each other are detected in the enlarged area, the contents enlarging processor 122 may decrease the size of the enlarged area having the diameter R to an area having a diameter R2 (R2<R) according to the length of drag progression. For another example, if two drags diverging from each other in the enlarged area are detected, the contents enlarging processor 122 may increase a magnification factor of contents according to the length of drag progression while maintaining the size of the enlarged area. For another example, if two drags converging with each other are detected in the enlarged area, the contents enlarging processor 122 may decrease the magnification factor of contents according to the length of drag progression while maintaining the size of the enlarged area.

In addition, if a touch is sensed on a corner of the rear side of the double-sided touch-sensitive display 130, the contents enlarging processor 122 may magnify the touch detected area as illustrated in FIG. 9.

In addition, if a touch is sensed on a corner of the rear side of the double-sided touch-sensitive display 130, the contents enlarging processor 122 may display a threshold area by enlarging the threshold area around a coordinate of the front side of the double-sided touch-sensitive display 130 corresponding to each coordinate at which the multi-touch is sensed, may detect a drag in each enlarged area, and may move each enlarged area according to a progression direction of the detected drag. For example, as illustrated in FIG. 10, on the rear side of the double-sided touch-sensitive display 130, if two touches are sensed on image contents displayed on the front side of the double-sided touch-sensitive display 130, touch-sensed two areas may be enlarged and displayed, a drag may be detected in each enlarged area, and each enlarged area may be moved according to a direction of the detected drag.

In addition, the contents enlarging processor 122 may display the enlarged area of contents in a circular or polygonal shape. For example, as illustrated in FIG. 11, the contents enlarging processor 122 may display an enlarged area in a quadrangular shape.

The touch sensing processor 124 may detect a touch on the front side and the rear side of the double-sided touch-sensitive display 130. First, the touch sensing processor 124 may detect a touch on the rear side of the double-sided touch-sensitive display 130 to enlarge a threshold area of contents displayed on the front side of the double-sided touch-sensitive display 130. In this case, if the double-sided touch-sensitive display 130 is set to be semi-transparent, the touch on contents displayed on the front side of the touch sensing processor 124 may be detected on the rear side of the double-sided touch-sensitive display 130.

In addition, the touch sensing processor 124 may detect a drag on the enlarged area to move the enlarged area of contents.

In addition, the touch sensing processor 124 may detect a gesture on the enlarged area to fix the enlarged area of contents. In this case, the gesture includes at least one of a tap for a specific time or longer, a multi-tap, a double-tap, and the like.

In addition, the touch sensing processor 124 may detect multiple touches on the enlarged area to regulate a size of the enlarged area or a magnification factor of contents. For example, the touch sensing processor 124 may detect two drags diverging from each other to increase the size of the enlarged area. For another example, the touch sensing processor 124 may detect drags converging with each other to decrease the size of the enlarged area.

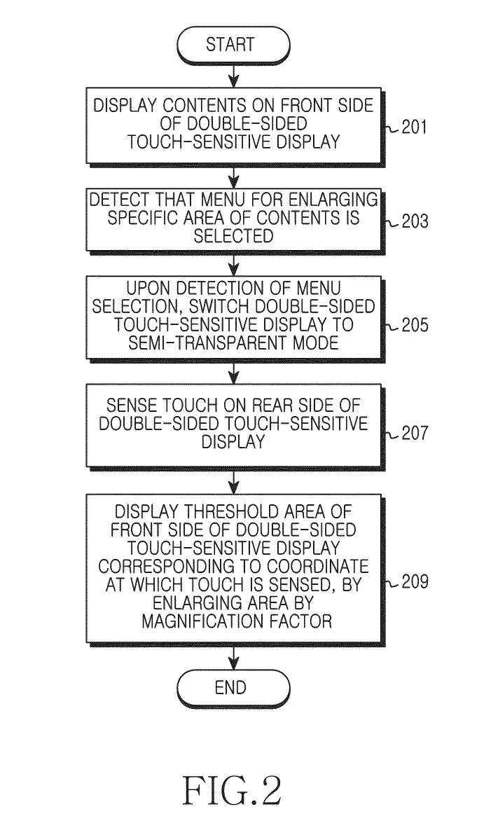

FIG. 2 illustrates a process of enlarging contents by sensing a touch on a rear side of a double-sided touch-sensitive display in an electronic device according to an embodiment of the present disclosure.

Referring to FIG. 2, the electronic device 100 displays the contents on the front side of the double-sided touch-sensitive display 130 at operation 201. For example, the electronic device 100 may display image contents on the front side of the double-sided touch-sensitive display 130. For another example, the electronic device 100 may display web-browser contents on the front side of the double-sided touch-sensitive display 130.

At operation 203, the electronic device 100 detects that a menu for enlarging a specific area of the contents is selected. In this case, the menu for enlarging the specific area of the contents is a menu for entering a magnifier mode.

At operation 205, upon the detection of the menu selection, the electronic device 100 switches the double-sided touch-sensitive display 130 to a semi-transparent mode. In this case, the electronic device 100 may set the double-sided touch-sensitive display 130 to be semi-transparent so that the user can simultaneously recognize contents displayed on the front side of the double-sided touch-sensitive display 130 and an object located on the rear side of the double-sided touch-sensitive display 130.

At operation 207, the electronic device 100 senses a touch on the rear side of the double-sided touch-sensitive display 130. In other words, on the rear side of the double-sided touch-sensitive display 130, the electronic device 100 senses a touch on the contents displayed on the front side of the double-sided touch-sensitive display 130.

At operation 209, the electronic device 100 displays a threshold area of the front side of the double-sided touch-sensitive display corresponding to a coordinate at which a touch is sensed, by enlarging the area by a magnification factor.

More specifically, the electronic device 100 senses the touch on the contents displayed on the front side of the double-sided touch-sensitive display 130 at the rear side of the double-sided touch-sensitive display 130, confirms the coordinate at which the touch is sensed, and enlarges the threshold area around the coordinate of the front side of the double-sided touch-sensitive display 130 by the magnification factor. In addition, if a specific area of the contents is enlarged with the magnification factor, the electronic device 100 may fix the magnification area under a user control, and thereafter may perform an additional operation on the enlarged area. For example, if image contents are enlarged by the magnification factor, the electronic device 100 may edit the enlarged area by using an image edit tool. For another example, if web-browser contents are enlarged by the magnification factor, the electronic device 100 may input a search word in the enlarged area.

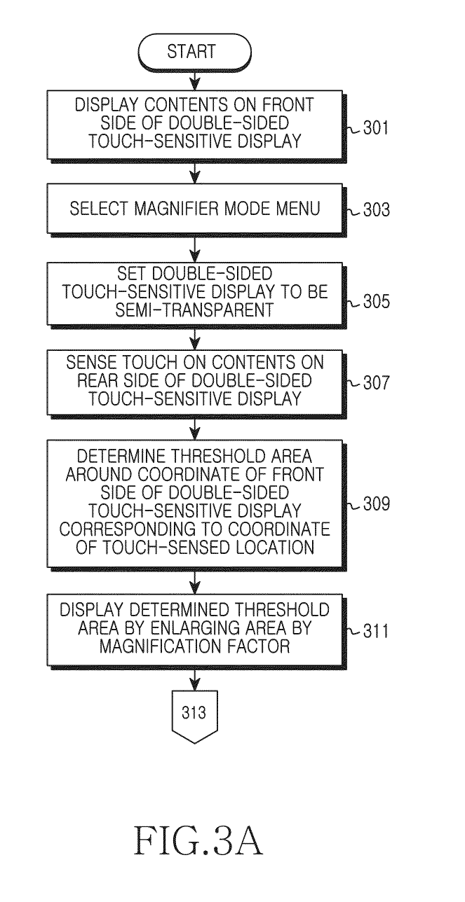

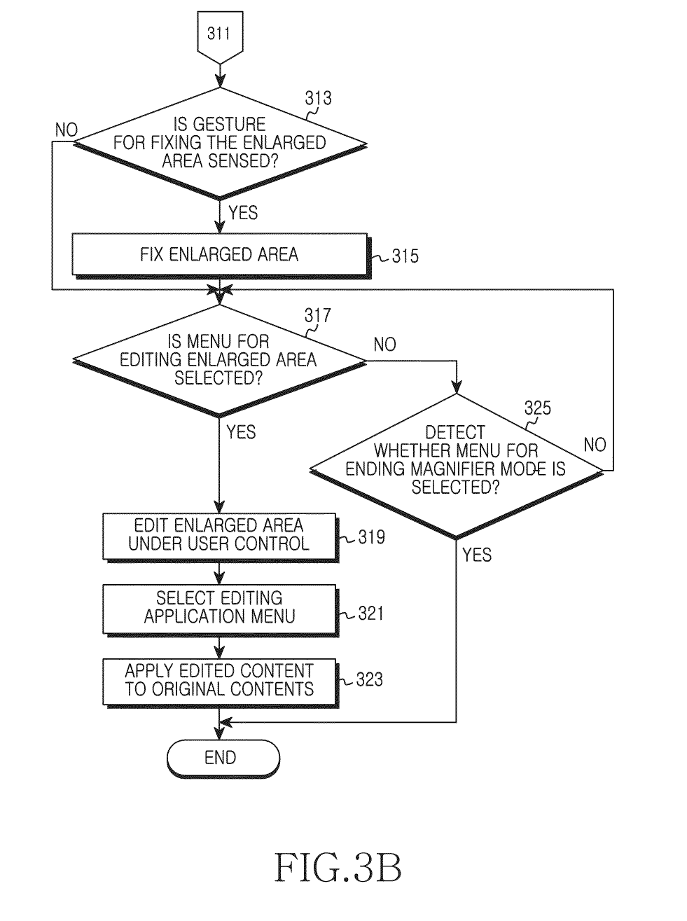

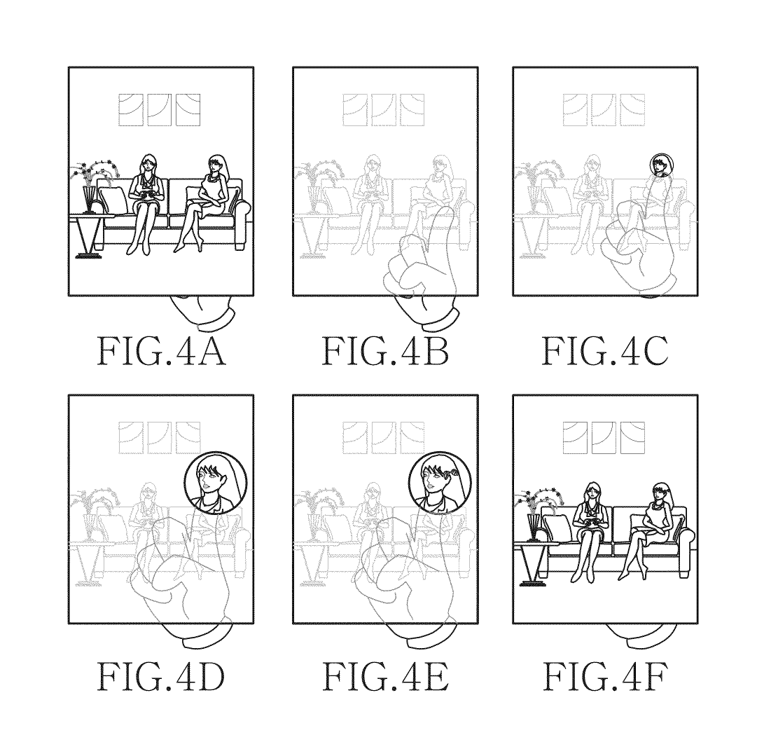

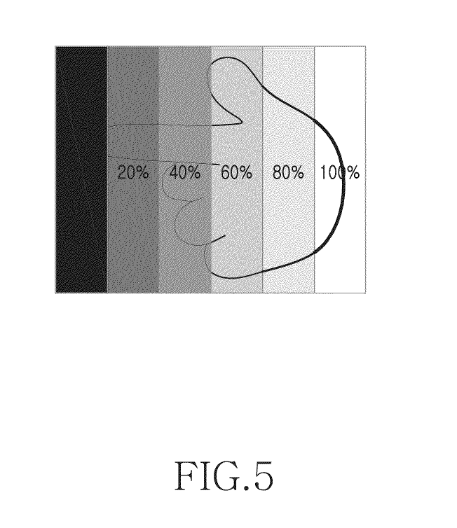

FIGS. 3A and 3B illustrate a process of enlarging and editing contents by using a double-sided touch-sensitive display in an electronic device according to an embodiment of the present disclosure. FIGS. 4A, 4B, 4C, 4D, 4E, and 4F illustrate an example of enlarging and editing contents by using a double-sided touch-sensitive display in an electronic device according to an embodiment of the present disclosure.

Referring to FIGS. 3A and 3B, the electronic device 100 displays contents on the front side of the double-sided touch-sensitive display 130 at operation 301. For example, as illustrated in FIG. 4A, the electronic device 100 may display image contents on the front side of the double-sided touch-sensitive display 130. In this case, since the double-sided touch-sensitive display 130 is set to be semi-transparent, as illustrated in FIG. 4A, a user's hand located on the rear side of the double-sided touch-sensitive display 130 is not reflected to the front side of the double-sided touch-sensitive display 130.

At operation 303, the electronic device 100 detects that a magnifier mode menu is selected. At operation 305, the electronic device 100 sets the double-sided touch-sensitive display 130 to be semi-transparent. In this case, by using the double-sided touch-sensitive display 130 which is set to be semi-transparent, the electronic device 100 may reflect an object located on the rear side of the double-sided touch-sensitive display 130 at the same time of displaying contents on the front side of the double-sided touch-sensitive display 130. For example, as illustrated in FIG. 4B, by setting the double-sided touch-sensitive display 130 to be semi-transparent, the electronic device 100 reflects the user's hand located on the rear side of the double-sided touch-sensitive display 130 at the same time of displaying image contents to the front side of the double-sided touch-sensitive display 130, so that the user can recognize a location of the user's hand.

At operation 307, the electronic device 100 senses a touch on contents on the rear side of the double-sided touch-sensitive display 130. In other words, on the rear side of the double-sided touch-sensitive display 130, the electronic device 100 senses a touch on contents displayed on the front side of the double-sided touch-sensitive display 130. For example, as illustrated in FIG. 4C, on the rear side of the double-sided touch-sensitive display 130, the electronic device 100 senses a touch on a specific location of image contents displayed on the front side of the double-sided touch-sensitive display 130.

At operation 309, the electronic device 100 determines a threshold area around a coordinate of the front side of the double-sided touch-sensitive display 130 corresponding to a coordinate of a touch-sensed location. In this case, a size and shape of the threshold area may be set in a design stage, and may change under the user control.

At operation 311, the electronic device 100 displays the determined threshold area by enlarging the area by a magnification factor. In this case, in a full area of the double-sided touch-sensitive display 130 which is set to be semi-transparent, only an enlarged area can be released from the semi-transparent setting by the electronic device 100. For example, as illustrated in FIG. 4D, the electronic device 100 may enlarge and display the threshold by the magnification factor, and may release the semi-transparent setting of the enlarged area.

At operation 313, the electronic device 100 determines whether a gesture for fixing the enlarged area is sensed. That is, the electronic device 100 determines whether a gesture occurs to maintain the enlarged area to an enlarged state until another event occurs.

Upon the sensing of the gesture for fixing the enlarged area, the electronic device 100 fixes the enlarged area at operation 315. Herein, the gesture includes at least one of a tap for a specific time or longer, a multi-tap, a double-tap, and the like. For example, upon the sensing of the tap for the specific time or longer with respect to the enlarged area, the electronic device 100 may fix the enlarged area. In addition, upon the sensing of the multi-touch on the enlarged area, the electronic device 100 may regulate a size of the enlarged area. For example, upon the sensing of two drags diverging from each other in the enlarged area, the electronic device 100 may increase the size of the enlarged area according to a length of drag progression. For another example, upon the sensing of two drags converging with each other in the enlarged area, the electronic device 100 may decrease the size of the enlarged area according to the length of drag progression.

At operation 317, the electronic device 100 detects whether a menu for editing the enlarged area is selected.

Upon the detection of the menu selection for editing the enlarged area, the electronic device 100 edits the enlarged area under a user control at operation 319. For example, as illustrated in FIG. 4E, the electronic device 100 may add a display effect to an enlarged area of image contents under the user control. For another example, if a search input window is enlarged and fixed under the user control in a state where a web browser is displayed, the electronic device 100 may input a text to the enlarged search input window.

At operation 321, the electronic device 100 detects that an editing application menu is selected. At operation 323, the electronic device 100 applies an edited content to original contents. More specifically, upon the selecting of the editing application menu, the electronic device 100 applies the edited content to the original contents, displays the enlarged area of the contents by reducing the area by an original magnification factor, and releases the semi-transparent setting of the double-sided touch-sensitive display 130. For example, if a display effect is added to the enlarged area of the image contents and thereafter the selection on the editing application menu is sensed, as illustrated in FIG. 4F, the electronic device 100 stores the display effect added to the enlarged area to original image contents, and thereafter reduces the enlarged area of the contents by a magnification factor of the original contents and releases the semi-transparent setting of the double-sided touch-sensitive display 130. Thereafter, the procedure of FIG. 3 ends.

If the menu selection for editing the enlarged area is not detected at operation 317, the electronic device 100 detects whether a menu for ending the magnifier mode is selected at operation 325.

If it is detected that the menu for ending the magnifier mode is selected, the electronic device 100 ends the magnifier mode. Thereafter, the procedure of FIG. 3 ends. Upon the ending of the magnifier mode, the electronic device 100 releases the semi-transparent setting of the double-sided touch-sensitive display 130.

Otherwise, if it is detected that the menu for ending the magnifier mode is not selected, returning to operation 317, the subsequent steps are repeated.

In addition, if the gesture for fixing the enlarged area is not detected at operation 311, proceeding to operation 325, the subsequent steps are repeated.

The electronic device 100 may detect the menu selection for setting to the magnifier mode, the gesture on the enlarged area, and the multi-touch on the enlarged area at the front side and/or the rear side of the double-sided touch-sensitive display 130.

In addition, although a case where the electronic device 100 displays contents only on the front side of the double-sided touch-sensitive display 130 is described above, it is also possible that the contents are displayed simultaneously on the front side and rear side of the double-sided touch-sensitive display 130. In this case, the electronic device 100 may display the contents displayed on the front side and rear side of the double-sided touch-sensitive display 130 simultaneously in a semi-transparent manner, and may enlarge and edit the contents according to a user's touch.

Various embodiments and all of the functional operations of the present disclosure described in this specification may be implemented in computer software, firmware, or hardware, including the structures disclosed in this specification and their structural equivalents, or in combinations of one or more of them. Further, the embodiments of the present disclosure described in this specification may be executed by one or more computer program products, i.e., an electronic device, a data processing device, etc., or may be implemented in one or more modules of computer program instructions encoded on a computer readable medium for controlling an operation of these devices.

The computer readable medium may be a machine-readable storage medium, a machine-readable storage substrate, a memory device, a composition of matter effecting a machine-readable propagated stream, or a combination of one or more of them. The term “data processing device” includes, for example, a programmable processor, a computer, or multiple processors or all apparatus, devices, and machines for processing data, including the computer. The apparatus may include, in addition to hardware, code that generates an execution environment for the computer program, e.g., code that constitutes processor firmware, a protocol stack, a database management system, an operating system, or a combination of one or more of them.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of processing contents in an electronic device, the method comprising:
displaying contents on a front side of a double-sided touch-sensitive display;
detecting a selection for enlarging a specific area of the contents;
upon the detection of the selection, switching the double-sided touch-sensitive display to a semi-transparent mode;
sensing a touch on a rear side of the double-sided touch-sensitive display; and
displaying a threshold area of the double-sided touch-sensitive display corresponding to a coordinate at which the touch is sensed by enlarging the area by a magnification factor.

2. The method of claim 1, further comprising setting a transparency for the enlarged threshold area in a full area of the double-sided touch-sensitive display to a value less than a current transparency of the double-sided touch-sensitive display.

3. The method of claim 1, further comprising:
detecting a gesture on the enlarged area; and
maintaining or ending the threshold area in an enlarged state.

4. The method of claim 3, further comprising editing the enlarged area of the contents under a user control in a state where the threshold area is enlarged.

5. The method of claim 4, further comprising:
applying the edited area to the contents; and
after the applying of the edited area to the contents, switching to a mode before the semi-transparent mode.

6. The method of claim 3, further comprising:
detecting that the enlarged area of the contents is selected under a user control in a state where the threshold area is enlarged; and
if it is detected that the enlarged area is selected, performing a function corresponding to the area on which the selection is detected,
wherein the function corresponding to the area on which the selection is detected includes at least one of a page change function, a link connection function, and a scroll function.

7. The method of claim 1, further comprising:
detecting at least two multi-touches for the enlarged area; and
if the detected at least two multi-touches are drags diverging from each other, increasing a size of an area displayed by enlarging the threshold area according to a drag distance.

8. The method of claim 7, further comprising, if the detected at least two multi-touches are drags converging with each other, decreasing the size of the area.

9. The method of claim 1, further comprising:
detecting at least two multi-touches on the enlarged area; and
if the detected at least two multi-touches are drags diverging from each other, increasing a magnification factor by which the threshold area according to the drag distance in a state where a size of the threshold area is maintained.

10. The method of claim 9, further comprising, if the detected at least two multi-touches are drags converging with each other, decreasing the magnification factor by which the threshold area according to the drag distance in the state where a size of the threshold area is maintained.

11. An electronic device comprising:
one or more processors;
a double-sided touch-sensitive display;
a memory; and
one or more programs stored in the memory and configured to be executed by the one or more processors,
wherein the one or more programs include an instruction for displaying contents on a front side of the double-sided touch-sensitive display, for detecting a selection for enlarging a specific area of the contents, for, upon the detection of selection, switching the double-sided touch-sensitive display to a semi-transparent mode, for sensing a touch on a rear side of the double-sided touch-sensitive display, and for displaying a threshold area of the double-sided touch-sensitive display corresponding to a coordinate at which the touch is sensed by enlarging the area by a magnification factor.

12. The electronic device of claim 11, wherein the program further includes an instruction for setting a transparency for the enlarged threshold area in a full area of the double-sided touch-sensitive display to a value less than a current transparency of the double-sided touch-sensitive display.

13. The electronic device of claim 11, wherein the program further includes an instruction for detecting a gesture on the enlarged area, and, maintaining or ending the threshold area in an enlarged state.

14. The electronic device of claim 13, wherein the program further includes an instruction for editing an enlarged area of the contents under a user control in a state where the threshold area is enlarged.

15. The electronic device of claim 14, wherein the program includes an instruction for applying the edited area to the contents, and, after the applying of the edited area to the contents, switching to a mode before the semi-transparent mode.

16. The electronic device of claim 13, wherein the program further includes an instruction for detecting that the enlarged area of the contents is selected under a user control in a state where the threshold area is enlarged, and if it is detected that the enlarged area is selected, for performing a function corresponding to the area on which the selection is detected, and
wherein the function corresponding to the area on which the selection is detected includes at least one of a page change function, a link connection function, and a scroll function.

17. The electronic device of claim 11, wherein the program further includes an instruction for detecting at least two multi-touches for the enlarged area, and, if the detected at least two multi-touches are drags diverging from each other, for increasing a size of an area displayed by enlarging the threshold area according to a drag distance.

18. The electronic device of claim 17, wherein the program further includes an instruction for, if the detected at least two multi-touches are drags converging with each other, decreasing the size of the area.

19. The electronic device of claim 11, wherein the program further includes an instruction for detecting at least two multi-touches on the enlarged area, and if the detected at least two multi-touches are drags diverging from each other, for increasing a magnification factor by which the threshold area according to the drag distance in a state where a size of the threshold area is maintained.

20. The electronic device of claim 19, wherein the program further includes an instruction for, if the detected at least two multi-touches are drags converging with each other, decreasing the magnification factor by which the threshold area according to the drag distance in the state where the size of the threshold area is maintained.
